(19) United States
(12) Patent Application Publication
(10) Pub. No.: US 2024/0054586 A1
(43) Pub. Date: Feb. 15, 2024

(54) SYSTEMS AND METHODS FOR AUTOMATED REAL ESTATE PROPERTY MATCHING ACROSS DISPARATE DATA SOURCES

(71) Applicant: JPMORGAN CHASE BANK, N.A., New York, NY (US)

(72) Inventors: Gurvinder Pal SINGH, Palatine (IL); Kevin WOO, New York, NY (US); Tania PARMAR, Arcadia, CA (US); Justin LAM, Cerritos, CA (US); Greg LEE, Fort Worth, TX (US); Suzanne M KRAHLING, Sammamish, WA (US); Vanessa MAI, Seattle, WA (US); Robin R BOLZ, Sammamish, WA (US)

(21) Appl. No.: 17/819,458

(22) Filed: Aug. 12, 2022

(51) Int. Cl. G06Q 50/16

(52) U.S. Cl. CPC G06Q 50/16

(57) ABSTRACT

Systems and methods for automated real estate property matching across disparate data sources are disclosed. A method may include: retrieving first property data and second property data; normalizing the first property data and the second property data; executing a first phase of a configurable systemic multi-step matching process to match a property in the first property data to the property in the second property data, the first phase outputting a first score; executing a second phase of the configurable systemic multi-step matching process, the second phase outputting a second score; determining that the first score to the second score are within a predetermined amount indicating an exact match; populating an entry in a unified property database with matching data from the first property data and the second property data; and storing the entry for the property in the unified property database.

### BACKGROUND OF THE INVENTION

### 1. Field of the Invention

Embodiments relate generally to systems and methods for automated real estate property matching across disparate data sources.

### 2. Description of the Related Art

In general, commercial real estate property data in the market is highly unstructured. For example, physical addresses have inconsistent formats across different datasets. Some addresses are abbreviated, the city names are different, the house number can be separated with a dash, the house number could be a range, etc. Each county and dataset may have its own way of formatting Assessor Parcel Numbers (“APNs”) with some counties and or datasets separating with numbers, some with dashes, and some with no separators. Latitude and longitude coordinates have different projections in different data sources, leading to different coordinates. In addition, some datasets store data on a per unit level, while others store data on a per property/building level. Some properties can have multiple sub addresses, and the same property can be divided by different owners. These inconsistencies present challenges when attempting to link the same piece of property collateral across different data sources.

### SUMMARY OF THE INVENTION

Systems and methods for automated real estate property matching across disparate data sources are disclosed. According to one embodiment, a method for automated real estate property matching across disparate data sources may include: (1) retrieving, by a property matching computer program executed by an electronic device, first property data from a first property data source, and second property data from a second property data source; (2) normalizing, by the property matching computer program, the first property data and the second property data; (3) executing, by the property matching computer program, a first phase of a configurable systemic multi-step matching process to match a property in the first property data to the property in the second property data, wherein the first phase comprises an address matching process or an Assessor Parcel Number (APN) matching process, the first phase outputting a first score; (4) executing, by the property matching computer program, a second phase of the configurable systemic multi-step matching process to match the property in the first property data to the property in the second property data, wherein the second phase comprises the other of the address matching process or the APN matching process, the second phase outputting a second score; (5) determining, by the property matching computer program, that the first score to the second score are within a predetermined amount indicating an exact match; (6) populating, by the property address matching computer program, an entry in a unified property database with matching data from the first property data and the second property data; and (7) storing, by the property matching computer program, the entry for the property in the unified property database.

In one embodiment, the first property data may include property addresses, and the second property data may include property addresses and APNs.

In one embodiment, an order of the first phase and the second phase may be selected based on a quality of the first property data or the second property data. In another embodiment, the order of the first phase and the second phase may be selected based on historical results of the first phase or the second phase.

In one embodiment, the order of the first phase and the second phase is configurable.

In one embodiment, the property matching computer program may not execute the second phase if the first phase returns an exact match.

In one embodiment, the exact match may be based on a street name having a score above a threshold and a matching house number.

According to another embodiment, a method for automated real estate property matching across disparate data sources may include: (1) retrieving, by a property matching computer program executed by an electronic device, first property data from a first property data source, and second property data from a second property data source; (2) normalizing, by the property matching computer program, the first property data and the second property data; (3) executing, by the property matching computer program, a first phase of a configurable systemic multi-step matching process to match a property in the first property data to the property in the second property data, wherein the first phase comprises an address matching process or an Assessor Parcel Number (APN) matching process, the first phase outputting a first score; (4) executing, by the property matching computer program, a second phase of the configurable systemic multi-step matching process to match the property in the first property data to the property in the second property data, wherein the second phase comprises the other of the address matching process or the APN matching process, the second phase outputting a second score; (5) determining, by the property matching computer program, that the first score to the second score are above 0 but below a threshold, indicating a partial exact match; and (6) populating, by the property address matching computer program, an entry in a unified property database for the property from the first property data and an entry in the unified property database for the property from the second property data, tagging each with a partial match indicator, and cross-referencing the other entry.

In one embodiment, the first property data may include property addresses, and the second property data may include property addresses and APNs.

In one embodiment, an order of the first phase and the second phase may be selected based on a quality of the first property data or the second property data. In another embodiment, the order of the first phase and the second phase may be selected based on historical results of the first phase or the second phase.

In one embodiment, the order of the first phase and the second phase is configurable.

In one embodiment, the property matching computer program may not execute the second phase if the first phase returns an exact match.

In one embodiment, the exact match may be based on a street name having a score above a threshold and a matching house number.

According to another embodiment, a non-transitory computer readable storage medium may include instructions stored thereon, that when read and executed by one or more computer processors, cause the one or more computer processors to perform steps comprising: retrieving first property data from a first property data source and second property data from a second property data source; normalizing the first property data and the second property data; executing a first phase of a configurable systemic multi-step matching process to match a property in the first property data to the property in the second property data, wherein the first phase comprises an address matching process or an Assessor Parcel Number (APN) matching process, the first phase outputting a first score; executing a second phase of the configurable systemic multi-step matching process to match the property in the first property data to the property in the second property data, wherein the second phase comprises the other of the address matching process or the APN matching process, the second phase outputting a second score; determining that the first score to the second score are within a predetermined amount indicating an exact match; populating an entry in a unified property database with matching data from the first property data and the second property data; and storing the entry for the property in the unified property database.

In one embodiment, the first property data may include property addresses, and the second property data may include property addresses and APNs.

In one embodiment, an order of the first phase and the second phase may be selected based on a quality of the first property data or the second property data. In another embodiment, the order of the first phase and the second phase may be selected based on historical results of the first phase or the second phase.

In one embodiment, the order of the first phase and the second phase is configurable.

In one embodiment, the property matching computer program may not execute the second phase if the first phase returns an exact match.

In one embodiment, the exact match may be based on a street name having a score above a threshold and a matching house number.

According to another embodiment, a system may include a plurality of property data sources and an electronic device executing a property matching computer program. The property matching computer program may: (1) retrieve first property data from a first property data source of the plurality of property data source, and second property data from a second property data source of the plurality of property data sources; (2) normalize the first property data and the second property data; (3) execute a first phase of a configurable systemic multi-step matching process to match a property in the first property data to the property in the second property data, wherein the first phase comprises an address matching process or an Assessor Parcel Number (APN) matching process, the first phase outputting a first score; (4) execute a second phase of the configurable systemic multi-step matching process to match the property in the first property data to the property in the second property data, wherein the second phase comprises the other of the address matching process or the APN matching process, the second phase outputting a second score; (5) determine that the first score to the second score are within a predetermined amount indicating an exact match; (6) populate an entry in a unified property database with matching data from the first property data and the second property data; and (7) store the entry for the property in the unified property database.

In one embodiment, the first property data may include property addresses, and the second property data may include property addresses and APNs.

In one embodiment, an order of the first phase and the second phase may be selected based on a quality of the first property data or the second property data. In another embodiment, the order of the first phase and the second phase may be selected based on historical results of the first phase or the second phase.

In one embodiment, the order of the first phase and the second phase is configurable.

In one embodiment, the property matching computer program may not execute the second phase if the first phase returns an exact match.

In one embodiment, the exact match may be based on a street name having a score above a threshold and a matching house number.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for automated real estate property matching across disparate data sources according to an embodiment;

FIG. 2 depicts a method for automated real estate property matching across disparate data sources according to an embodiment; and

FIG. 3 depicts an exemplary computing system for implementing aspects of the present disclosure.

### DETAILED DESCRIPTION OF PREFERRED EMBODIMENTS

Embodiments relate generally to systems and methods for automated real estate property matching across disparate data sources. Embodiments provide a link for the same property across multiple data sources, both internal to and external to an organization using data points, and may establish a unified, clean source of truth for property and geography fields. Examples of data points may include property address, property tax assessor's parcel number (APN), reported owner, reported owner mailing address, property sale document number, last sale date of property, property latitude and longitude, etc.

The unified, clean source of truth may further enable property-based analytics (e.g., customer acquisitions, valuations, etc.) and may be used to train and implement models.

Embodiments may match a property's address and APN using a comparison scoring method. Embodiments may further use a waterfall-based approach to link real estate properties across data sources.

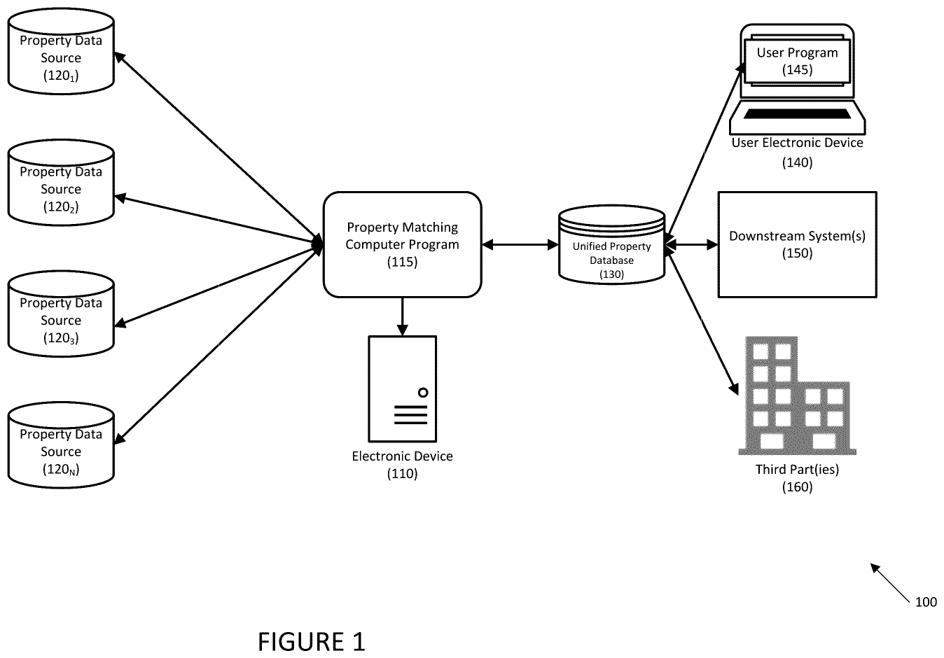

Referring to FIG. 1, a system for automated real estate property matching across disparate data sources is disclosed according to an embodiment. System 100 may include backend electronic device 110 which may be any suitable electronic device, including servers (cloud and/or physical), computers (e.g., workstations, desktops, laptops, notebooks, tablets, etc.), etc. Backend electronic device 110 may execute property matching computer program 115.

Property matching computer program 115 may retrieve property data from a plurality of property data sources 120 (e.g., property data sources 120₁, property data sources 120₂, property data sources 120₃, . . . property data sources 120_{N}). Property data sources 120 may store property data including, for example, addresses, APNs, reported owners, reported owner mailing addresses, property sale document number, last sale date of property, property latitude and longitude, etc. Property matching computer program 115 may match property data from property data sources 120 and may output unified property data to unified property database 130. User program 145 executed by user electronic device 140 (e.g., a computer, smart device, Internet of Things (IoT) device, terminal, kiosk, etc.), downstream systems 150, and/or third parties 160 may access unified property database 130 and may execute queries.

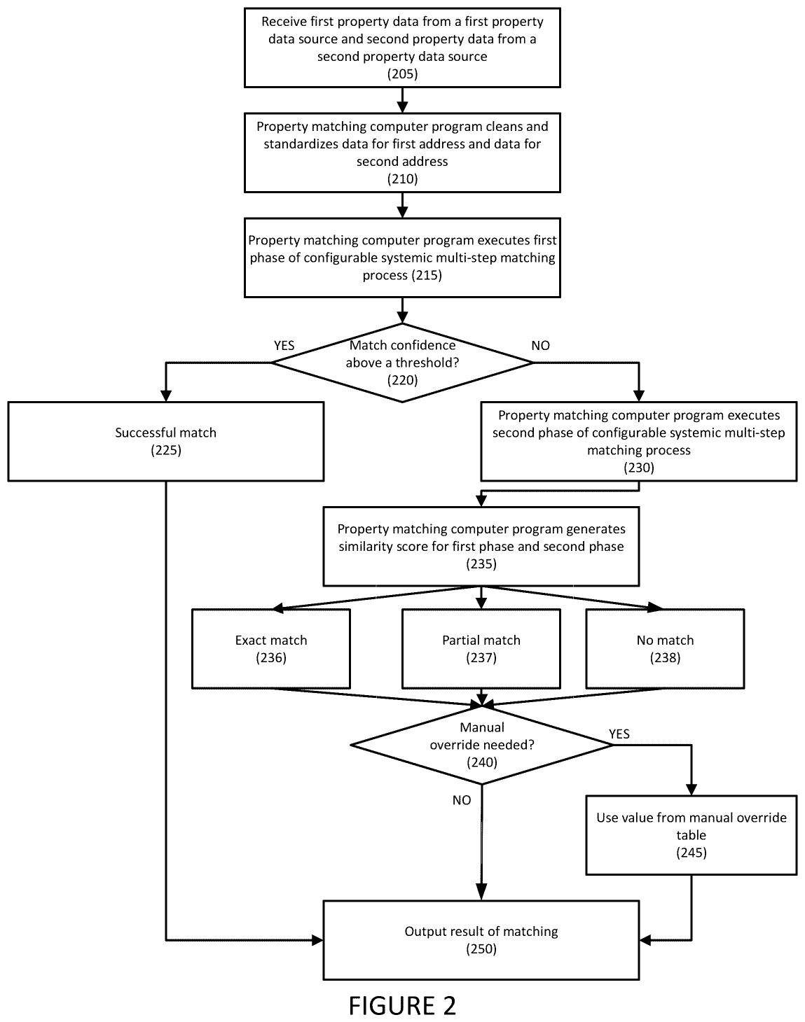

Referring to FIG. 2, a method for automated real estate property matching across disparate data sources is disclosed according to an embodiment.

In step 205, a property matching computer program executed by an electronic device may retrieve property data from a plurality of data sources. For example, the property matching computer program may retrieve first property data from a first property data source, and second property data from a second property data source. The first property data may include a property address, and the second property data may include a property address and an APN.

In step 210, the property matching computer program may clean and standardize the data for first address and data for second address. For example, the property matching computer program may normalize the data so that it has a standard format.

In step 215, the property matching computer program may execute a first phase of a configurable systemic multi-step matching process. For example, the property matching computer program may start with an address matching process, or it may start with an APN matching process. The matching process may be selected based on, for example, the quality of the data (e.g., completeness of the data), machine learning based on historical results (e.g., address matching provides a higher success rate than APN matching), or any other suitable reason.

In one embodiment, both address matching and APN matching may be performed at the same time.

In step 220, if the match confidence is above a threshold, in step 225, the match may be considered to be a successful match, and in step 250, the result of the match may be updated.

If the match confidence is not above the threshold, if not already executed in step 215, in step 230, the property matching computer program may execute a second phase of the configurable systemic multi-step matching process. For example, if address matching was performed in step 215, then APN matching is performed in step 230. Conversely if APN matching was performed in step 215, then address matching is performed in step 230.

In step 235, the property matching computer program may compare the results from the first phase of the matching process and the second phase of the matching process and may generate a similarity score, resulting in an exact match (236), partial match (237), or no match (238). For example, if the similarity score for the street name is over a threshold (e.g., 0.90) and the house numbers match, the two property data may be considered as having an exact match.

If the similarity score is above 0 but below the threshold, the property data may be considered to have a partial match. The property matching computer program may tag the record to indicate that a partial match was found, and store the tagged record with the potential matched record details in a database. For example, the records in each database may be tagged to indicate a partial match.

If the similarity score is zero, the property data may be considered to be no match.

For both the partial match (237) and no match (238) results, the records may be reviewed to find the root cause of not finding a good match between sources, such as one of the sources not having the property, data quality issues on either source, etc. This review may be a manual review.

In case the review does find a match, an override table may be used to log that match so that it can be leveraged for building a unified property database.

Once a match is identified, in step 240, the match may be checked to see if a manual override is needed. In one embodiment, a score may be assigned to the match based on the similarity (e.g., 75% match), and if the score is below a threshold, a manual override may be initiated.

If a manual override is needed, in step 245, a user may enter a manual override.

If a manual override is not needed, or after the manual override is entered, in step 250, the match may be output. In one embodiment, the match may be stored in a unified property database. For example, embodiments may populate matched result tables with the results, and the matched results tables may be used for reporting and business use cases.

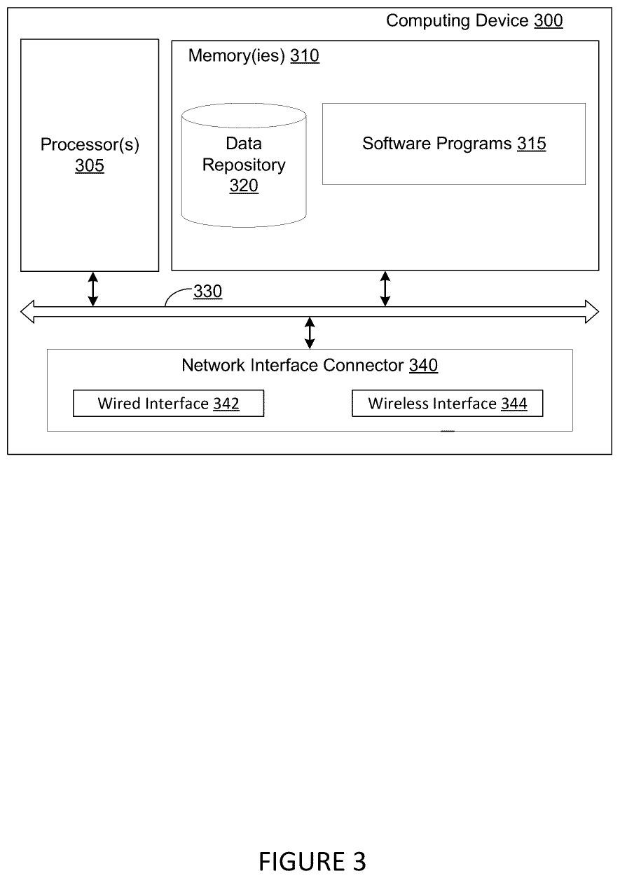

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for automated real estate property matching across disparate data sources, comprising:
retrieving, by a property matching computer program executed by an electronic device, first property data from a first property data source, and second property data from a second property data source;
normalizing, by the property matching computer program, the first property data and the second property data;
executing, by the property matching computer program, a first phase of a configurable systemic multi-step matching process to match a property in the first property data to the property in the second property data, wherein the first phase comprises an address matching process or an Assessor Parcel Number (APN) matching process, the first phase outputting a first score;
executing, by the property matching computer program, a second phase of the configurable systemic multi-step matching process to match the property in the first property data to the property in the second property data, wherein the second phase comprises the other of the address matching process or the APN matching process, the second phase outputting a second score;
determining, by the property matching computer program, that the first score to the second score are within a predetermined amount indicating an exact match;
populating, by the property address matching computer program, an entry in a unified property database with matching data from the first property data and the second property data; and
storing, by the property matching computer program, the entry for the property in the unified property database.

2. The method of claim 1, wherein the first property data comprises property addresses, and the second property data comprises property addresses and APNs.

3. The method of claim 1, wherein an order of the first phase and the second phase is selected based on a quality of the first property data or the second property data.

4. The method of claim 1, wherein an order of the first phase and the second phase is selected based on historical results of the first phase or the second phase.

5. The method of claim 1, wherein the order of the first phase and the second phase is configurable.

6. The method of claim 1, wherein the property matching computer program does not execute the second phase if the first phase returns an exact match.

7. The method of claim 1, wherein the exact match comprises a street name having a score above a threshold and a matching house number.

8. A method for automated real estate property matching across disparate data sources, comprising:
retrieving, by a property matching computer program executed by an electronic device, first property data from a first property data source, and second property data from a second property data source;
normalizing, by the property matching computer program, the first property data and the second property data;
executing, by the property matching computer program, a first phase of a configurable systemic multi-step matching process to match a property in the first property data to the property in the second property data, wherein the first phase comprises an address matching process or an Assessor Parcel Number (APN) matching process, the first phase outputting a first score;
executing, by the property matching computer program, a second phase of the configurable systemic multi-step matching process to match the property in the first property data to the property in the second property data, wherein the second phase comprises the other of the address matching process or the APN matching process, the second phase outputting a second score;
determining, by the property matching computer program, that the first score to the second score are above 0 but below a threshold, indicating a partial exact match; and
populating, by the property address matching computer program, an entry in a unified property database for the property from the first property data and an entry in the unified property database for the property from the second property data, tagging each with a partial match indicator, and cross-referencing the other entry.

9. The method of claim 8, wherein the first property data comprises property addresses, and the second property data comprises property addresses and APNs.

10. The method of claim 8, wherein an order of the first phase and the second phase is selected based on a quality of the first property data or the second property data.

11. The method of claim 8, wherein an order of the first phase and the second phase is selected based on historical results of the first phase or the second phase.

12. The method of claim 8, wherein the order of the first phase and the second phase is configurable.

13. The method of claim 8, further comprising:
determining, by the property matching computer program, a root cause for the partial match.

14. A non-transitory computer readable storage medium, including instructions stored thereon, which when read and executed by one or more computer processors, cause the one or more computer processors to perform steps comprising:
retrieving first property data from a first property data source and second property data from a second property data source;
normalizing the first property data and the second property data;
executing a first phase of a configurable systemic multi-step matching process to match a property in the first property data to the property in the second property data, wherein the first phase comprises an address matching process or an Assessor Parcel Number (APN) matching process, the first phase outputting a first score;
executing a second phase of the configurable systemic multi-step matching process to match the property in the first property data to the property in the second property data, wherein the second phase comprises the other of the address matching process or the APN matching process, the second phase outputting a second score;
determining that the first score to the second score are within a predetermined amount indicating an exact match;
populating an entry in a unified property database with matching data from the first property data and the second property data; and
storing the entry for the property in the unified property database.

15. The non-transitory computer readable storage medium of claim 14, wherein the first property data comprises property addresses, and the second property data comprises property addresses and APNs.

16. The non-transitory computer readable storage medium of claim 14, wherein an order of the first phase and the second phase is selected based on a quality of the first property data or the second property data.

17. The non-transitory computer readable storage medium of claim 14, wherein an order of the first phase and the second phase is selected based on historical results of the first phase or the second phase.

18. The non-transitory computer readable storage medium of claim 14, wherein the order of the first phase and the second phase is configurable.

19. The non-transitory computer readable storage medium of claim 14, wherein the property matching computer program does not execute the second phase if the first phase returns an exact match.

20. The non-transitory computer readable storage medium of claim 14, wherein the exact match comprises a street name having a score above a threshold and a matching house number.
